(19) United States
(12) Patent Application Publication
(10) Pub. No.: US 2002/0080172 A1
(43) Pub. Date: Jun. 27, 2002

(54) Pointer control system

(76) Inventor: John R.M. Viertl, Niskayuna, NY (US)

Correspondence Address: PERKINS COIE LLP, PATENT-SEA, P.O. BOX 1247, SEATTLE, WA, 98111-1247, US

(21) Appl. No.: 09/750,484

(22) Filed: Dec. 27, 2000

(51) Int. Cl. G09G 5/00

(52) U.S. Cl. 345/751

(57) ABSTRACT

A method and system for displaying multiple pointers on a display device is provided. In one embodiment, the pointer system is used when an application program is to be shared by multiple participants. At each participant's computer, the pointer system displays a pointer for each participant. When one participant moves their pointer, the pointer system updates that participant's pointer on the display of the other participant computers. In addition, the pointer system may display each pointer in a visually distinct manner, so that the participants can identify which pointer belongs to which participant.

### TECHNICAL FIELD

The described technology relates to displaying pointers on a display device.

### BACKGROUND

The modern workplace is increasingly reliant on the use of computer networks. A network is a group of computer systems that are connected by a communications mechanism, such as the Internet. A network enables the transfer of electronic information between the computer systems. For example, several computer systems may cooperatively interact to effect the sharing of an application program. Such application sharing allows a host computer to execute the application program while the output is displayed not only at the host computer, but also at other participant computers.

Different application sharing systems allow the participants to have different levels of control over the application program. An application sharing system may allow participants to view the output of the application program only, and provide no input. In such an application sharing system, the participant at the host computer provides all the input to the application program. Another application sharing system may allow each participant to provide input to the application program. Such an application sharing system typically uses a mediation algorithm to identify the participant who can currently input data into the application program.

“Electronic conferencing” refers to the process of conducting a conference using a computer to display information during the conference. Electronic conferences often use a “whiteboard” application program through which the participants can provide data that is displayed to the other participants. A whiteboard application program may be implemented as a distributed application program that is executed on each participant's computer. Each whiteboard application program executing on a participant computer would exchange information with the whiteboard application programs executing on the other participant computers. Such an implementation is referred to as a peer-based system because no participant computer serves as the host computer. Alternatively, the whiteboard application program may execute at a host computer, and an application sharing system may be used to communicate with the participant computers.

Electronic conferencing has been used in many environments to help reduce travel costs and improve the understanding of and communications between the participants. For example, when attempting to diagnose problems with complex equipment, such as a gas turbine at a power plant, an application sharing system may be used to display images of the equipment both at the plant site and at one or more remote sites where engineers may be located. The participants may conduct a telephone conference simultaneously with the electronic conference. Typically, one participant takes control of the application program and moves the pointer to different portions of the displayed equipment as the conference proceeds. Depending on the application sharing system, different participants may be able to take control at different times.

A difficulty with conducting such electronic conferences is that each participant needs to wait their turn to take control of the application program in order to point to different portions of the display generated by the application program. It would be desirable to have a technique that would allow multiple participants to point to different portions of the display simultaneously.

### BRIEF DESCRIPTION OF DRAWINGS

FIG. 1 illustrates the display page with multiple pointers.

FIG. 2 illustrates a display page with multiple pointers and multiple windows.

FIG. 3 illustrates different forms of pointers.

FIG. 4 is a block diagram illustrating components of the pointer system in one embodiment.

FIG. 5 is a flow diagram of the launch application component of the server system.

FIG. 6 is a flow diagram illustrating the processing of the process application output component in one embodiment.

FIG. 7 is a flow diagram illustrating the processing of the process application input in one embodiment.

FIG. 8 is a flow diagram illustrating the processing of the process pointer movement component in one embodiment.

FIG. 9 is a flow diagram illustrating the processing of the collect pointer events component of a client computer in one embodiment.

### DETAILED DESCRIPTION

A method and system for displaying multiple pointers on a display device is provided. In one embodiment, the pointer system is used when an application program is to be shared by multiple participants. At each participant's computer, the pointer system displays a pointer for each participant. When one participant moves their pointer, the pointer system updates that participant's pointer on the display of the other participant computers. In addition, the pointer system may display each pointer in a visually distinct manner so that the participants can identify which pointer belongs to which participant. In this way, the participants can simultaneously point to different portions of the display generated by the application program.

In one embodiment, the pointer system operates as a front end to an application program that is to be shared while an electronic conference is conducted. The front-end component receives output from the application program and forwards the output to the participant computers. The front-end component receives input from a participant computer and forwards the input to the application program. The front-end component also receives pointer movement events from the participant computers. Upon receiving a pointer movement event, the front-end component forwards an indication of the pointer movement event to each other participant computer. Alternatively, the pointer system may operate as pointer management component that manages the display of the pointers for the participants without receiving any input or output from the underlying application program. In this embodiment, the pointer system may receive and forward pointer movement without any knowledge of the application program that may be executing. The term “pointer” as used in the detailed description refers to a pointer that is generally independent of the pointer that may be provided by the application program itself. The pointer of the participants will generally have no effect on the underlying application program. One skilled in the art will appreciate, however, that the pointer for the participant who is in control may be the pointer provided by the application program.

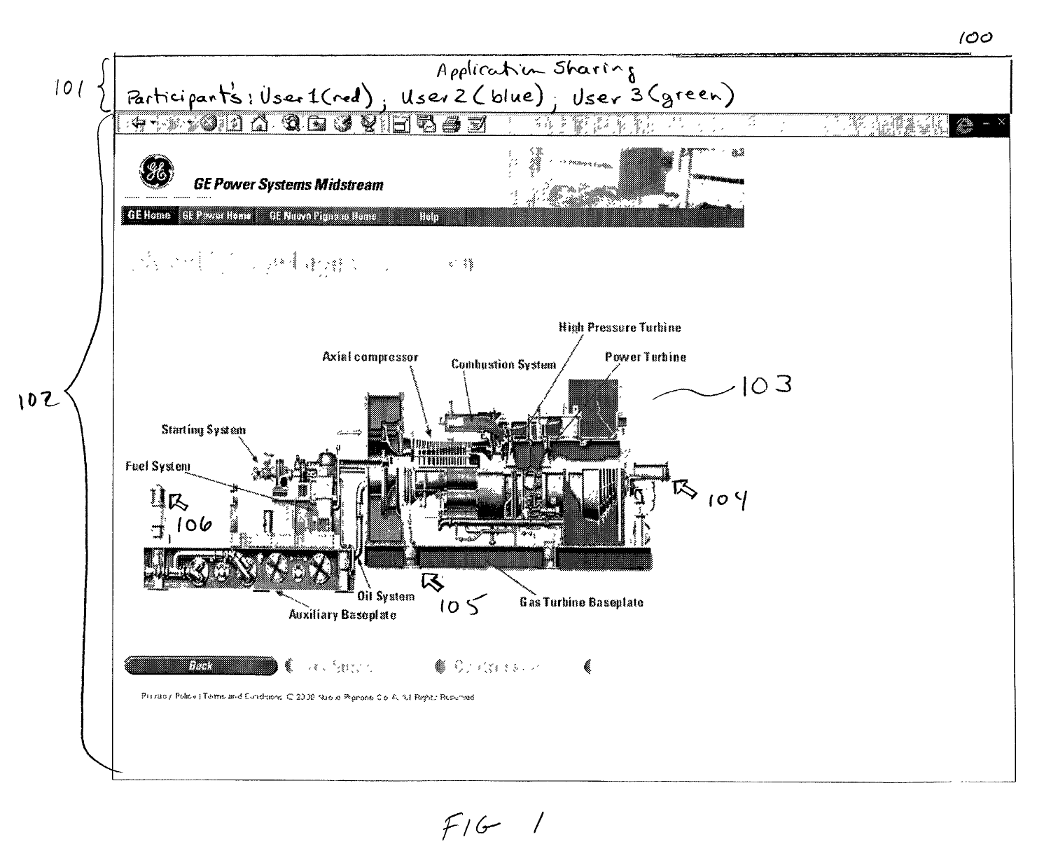

FIG. 1 illustrates the display page with multiple pointers. Display page 100 includes a participant identification area 101 and an application display area 102. The application display area includes a graphic image 103 that represents a gas turbine. This display page displays the pointers 104, 105, and 106 for three different participants. In this example, the pointers may be displayed in different colors, as indicated by the identification area, to identify which participant is associated with which pointer. As one participant moves a pointer to another portion of the display page, the pointer system updates the displays of the other participant computers.

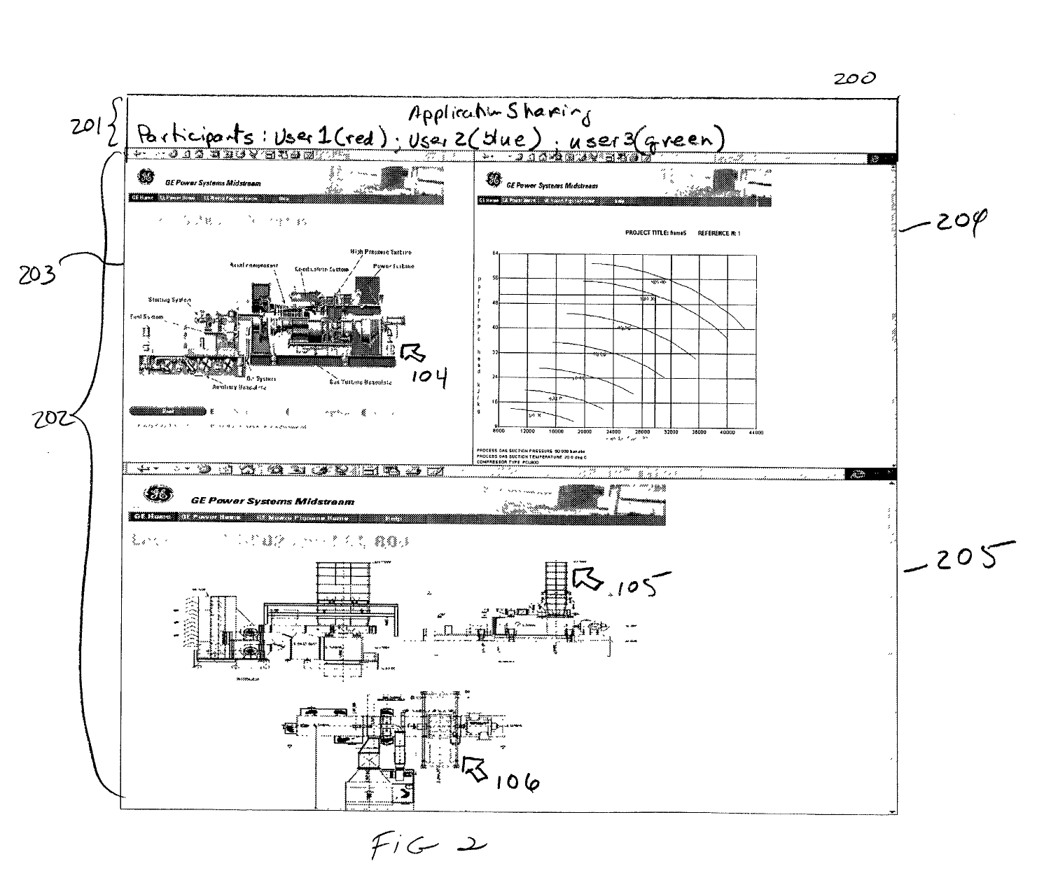

FIG. 2 illustrates a display page with multiple pointers and multiple windows. Display page 200 includes a participant identification area 201 and an application display area 202. In this example, the application display area includes windows 203, 204, and 205. The application program that is being shared may allow a host computer or other participant computer to open and arrange various windows. As illustrated, a participant can move their pointer to point to data in any of the windows.

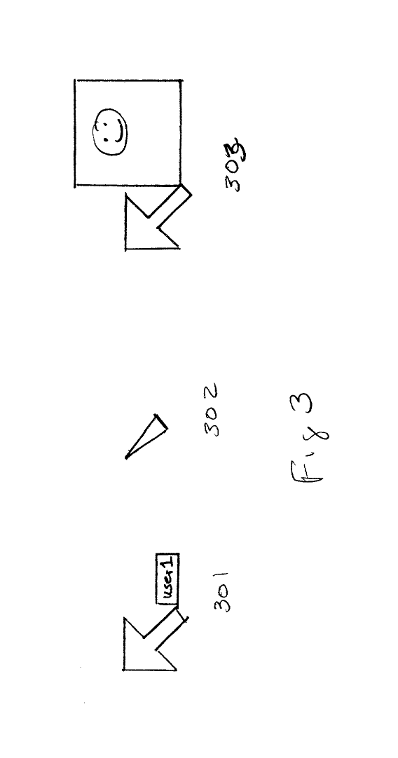

FIG. 3 illustrates different forms of pointers. As discussed above, the pointer system may use different colors to distinguish the pointers of the different participants. In addition, the pointer 301 may include the name of the participant in the area near the pointer. Alternatively, the pointer system may use different shaped pointers 302 for each participant. The pointer system may also display an image associated with the participant, such as a corporate logo or photograph of the participant, near the pointer 303.

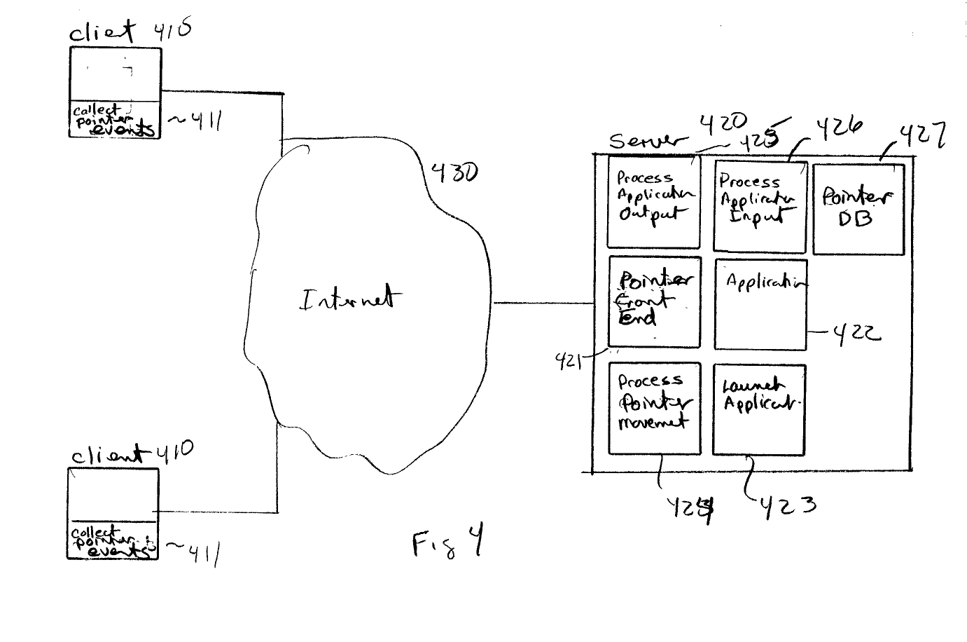

FIG. 4 is a block diagram illustrating components of the pointer system in one embodiment. The client computers 410 and the server computer 420 are interconnected via the Internet 430. The computers may include a central processing unit, memory, input devices (e.g., keyboard and pointing devices), output devices (e.g., display devices), and storage devices (e.g., disk drives). The memory and storage devices are computer-readable media that may contain instructions that implement the pointer system. In addition, the data structures and message structures, including pointer movement events, may be stored or transmitted via a data transmission medium, such as a signal on a communications link. Communications channels other than the Internet may be used, such as local area networks, wide area networks, or point-to-point dial-up connections. The client computers include a collect pointer events component 411. The collect pointer events component monitors the participant's input to detect when the participant indicates to move their pointer. The collect pointer events component then sends a pointer movement event notification to the server computer. The server computer includes a pointer front-end component 421, an application program 422, a launch application component 423, a process pointer movement component 424, a process application output component 425, a process application input component 426, and a pointer database 427. The pointer front-end component controls the launching of the application program, the transferring of application input and output data, and the processing of pointer event movement notifications. The process pointer movement component is invoked when notification is received from a client computer that a participant has moved their pointer. The process pointer movement component then sends a message to each other client computer to effect the change in the location of the pointer at the client computer. The pointer data base contains information that indicates the current location of the pointer for each participant. It may also contain an indication of the distinguishing characteristic (e.g., color) of the pointer for each participant.

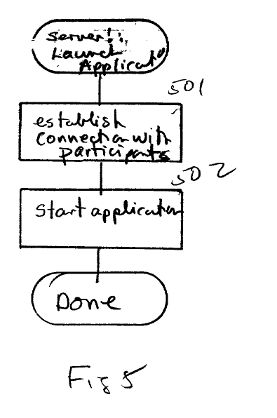

FIGS. 5-9 are flow diagrams illustrating the processing of the pointer system in one embodiment. FIG. 5 is a flow diagram of the launch application component of the server computer. This component establishes a connection with the participant computers. This component may also generate the participant identification area to be displayed at each participant computer. This component may be passed the identification of each of the participants. In block 501, the component establishes a connection with the computer of each participant. The connections can be established using various communication protocols, such as TCP/IP. The pointer system may alternatively use connectionless protocols, such as HTTP. In block 502, the component starts the application program and then completes.

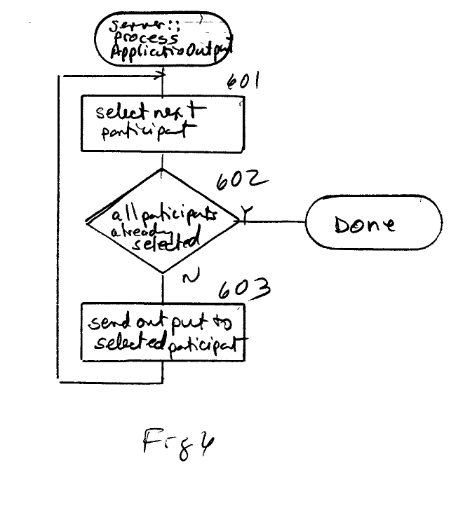

FIG. 6 is a flow diagram illustrating the processing of the process application output component in one embodiment. This component receives the output of the application program and forwards it to the various participant computers for display. In block 601, the component selects the next participant starting with the first. In decision block 602, if all the participants have already been selected, then the component completes, else the component continues at block 603. In block 603, the component sends the output to the computer of the selected participant. The component then loops to block 601 to select the next participant.

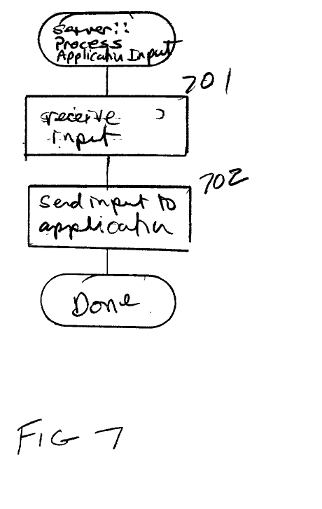

FIG. 7 is a flow diagram illustrating the processing of the process application input in one embodiment. This component receives the input from the participant computers that is directed to the application program and forwards the input to the application program. In block 701, the component receives input from a participant computer. In block 702, the component sends the input to the application program and then completes.

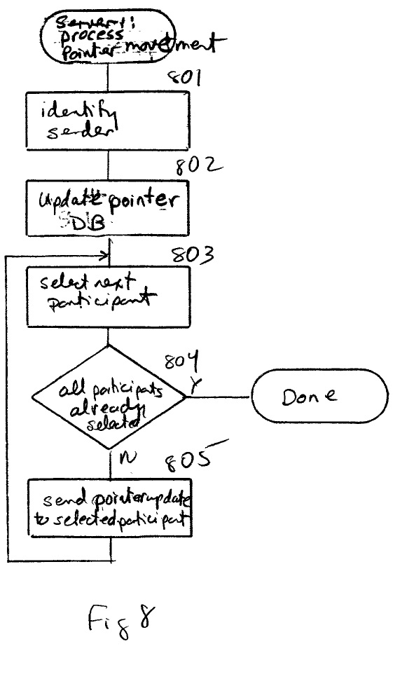

FIG. 8 is a flow diagram illustrating the processing of the process pointer movement component in one embodiment. This component receives an indication of pointer movement by a participant computer. The component then sends a notification to each participant computer that effects the movement of the pointer. In block 801, the component identifies the participant who sent the pointer movement event. In block 802, the component updates the pointer database to indicate the new location of the participant's pointer. The pointer system may use the pointer database to display pointers when a new participant joins the conference. In block 803-805, the component loops sending a pointer update notification to each participant computer. In block 803, the component selects the next participant. In decision block 804, if all the participants have already been selected, then the component completes, else the component continues at block 805. In block 805, the component sends pointer update information to the computer of the selected participant. The pointer update information may include a completely new display page to replace the currently displayed display page. Alternatively, if the participant computers have a component that controls the displaying of pointers, then the pointer update notification may include an instruction to move the pointer. The component then loops to block 803 to select the next participant.

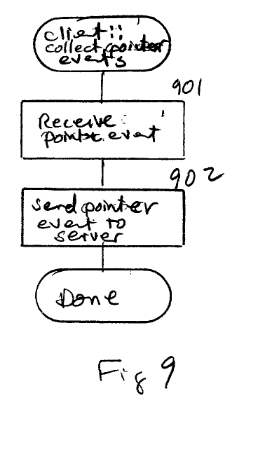

FIG. 9 is a flow diagram illustrating the processing of the collect pointer events component of a client computer in one embodiment. In block 901, the component receives a pointer movement event as a result of a participant indicating to move their pointer. A participant may indicate to move their pointer by, for example, moving their pointing device (e.g., mouse). In block 902, the component sends the pointer movement event to the server computer and then completes.

From the above description, it will be appreciated that although specific embodiments of the pointer system have been described for purposes of illustration, various modifications may be made without deviating from the spirit and scope of the invention. In particular, the use of multiple pointers can be used to improve conferences that do not rely on computer-generated pointers. For example, during a presentation the attendees may each have pointing devices (e.g., a laser) for displaying pointers with different visual characteristics (e.g., color or shape) so that more than one attendee can be pointing to the presentation at the same time. Accordingly, the invention is defined by the appended claims.

1. A method in a computer system for conducting an application sharing session, the method comprising:
identifying participant computers that will share an application;
sending a display page generated by the application to each participant computer; and
when a pointer event is received from a participant computer, sending an indication of the pointer event to each participant computer
whereby each participant computer displays a separate pointer for each participant and updates the pointers when it receives the sent indications of pointer events.

2. The method of claim 1 wherein each pointer is displayed in a form to uniquely identify the participant computer.

3. The method of claim 1 wherein each pointer is displayed in a different color.

4. The method of claim 1 wherein each pointer is displayed in a different shape.

5. The method of claim 1 wherein a participant name is displayed near each pointer.

6. The method of claim 1 wherein an image representing a participant is displayed near each pointer.

7. A method in a computer system for conducting an electronic conference among participant computers, the method comprising:
receiving a display page with information relating to the conference;
displaying the received display page; and
for each of a plurality of participant computers,
receiving an indication of a pointer event generated by the participant computer, each participant computer having a separate pointer; and
updating a display of the pointer for the participant computer whereby multiple pointers are displayed simultaneously over the display page.

8. The method of claim 7 wherein the visual representation of each pointer is different.

9. A method in a computer system for displaying pointers on a display device, the method comprising:
displaying a pointer for each of a plurality of users, wherein the pointers are displayed simultaneously;
receiving an indication that a user has indicated to move their pointer; and
in response to receiving the indication, updating the display of the pointer for that user to reflect the indication to move the pointer.

10. The method of claim 9 wherein the displayed pointers overlay a display of information.

11. The method of claim 9 including displaying a display page generated by an application that is shared by the users.

12. The method of claim 9 wherein each user has a computer.

13. The method of claim 9 wherein the displayed pointers are visually distinct.

14. A computer system for managing pointers for different users, each user having a user computer, the system comprising:
an application program; and
a pointer component that receives pointer events generated by a user computer in response to the user indicating to move their pointer and distributes the pointer events to the other user computers so that a user computer can display a pointer for each user computer and can update the displayed pointers.

15. The computer system of claim 14 wherein the pointer component intercepts output of the application program and forwards the output to the user computers for display.

16. The computer system of claim 14 wherein each displayed pointer is visually distinct.

17. A computer-readable medium for controlling a computer system to display pointers on a display device, by a method comprising:
displaying a pointer for each of a plurality of users, wherein the pointers are displayed simultaneously;
receiving an indication that a user has indicated to move their pointer; and
in response to receiving the indication, updating the display of the pointer for that user to reflect the indication to move.

18. The computer-readable medium of claim 17 wherein the displayed pointers overlay a display of information.

19. The computer-readable medium of claim 17 including displaying a display page generated by an application that is shared by the users.

20. The computer-readable medium of claim 17 wherein the displayed pointers are visually distinct.

21. The computer-readable medium of claim 17 wherein each pointer is displayed in a different color.

22. The computer-readable medium of claim 17 wherein each pointer is displayed in a different shape.

23. The computer-readable medium of claim 17 wherein a participant name is displayed near each pointer.

24. The computer-readable medium of claim 17 wherein an image representing a participant is displayed near each pointer.
